(19) United States
(12) Patent Application Publication
(10) Pub. No.: US 2003/0074478 A1
(43) Pub. Date: Apr. 17, 2003

(54) Media gateway

(76) Inventor: Nick Ramirez, Gilbert, AZ (US)

Correspondence Address: FISH & RICHARDSON, PC, 4350 LA JOLLA VILLAGE DRIVE, SUITE 500, SAN DIEGO, CA, 92122, US

(21) Appl. No.: 09/978,412

(22) Filed: Oct. 15, 2001

(51) Int. Cl. H04B 1/66; H04N 7/12; H04N 11/02; H04N 11/04; G06F 15/16; G06F 15/163

(52) U.S. Cl. 709/247; 375/240.26; 375/240; 709/311

(57) ABSTRACT

A media gateway includes an interface device, a digital signal processor, and a network processor. The interface device receives a telephone number, translates the telephone number to an Internet Protocol address, and opens a channel over a network using the Internet Protocol address. The digital signal processor receives pulse-code modulated voice data, compresses the pulse-code modulated voice data, and generates data packets that correspond to the compressed pulse-code modulated voice data. The network processor receives the Internet Protocol address from the interface device, receives the data packets from the digital signal processor, and directs the data packets to the network in accordance with the Internet Protocol address.

### TECHNICAL FIELD

This invention relates generally to a media gateway and, more particularly, to a media gateway that includes a digital signal processor that packetizes data and a network processor that directs the resulting data packets to a network.

### BACKGROUND

To implement voice-over Internet Protocol (VOIP), audio information is packetized and the resulting data packets are transmitted over a network, such as the Internet, between two devices. Streaming video is implemented in much the same way. That is, video information is packetized and the resulting data packets are transmitted over a network between two devices. A network processor may be used to regulate the flow of packet traffic, including VOIP or streaming video packets, on the network. For example, a network processor may be used to redirect packet traffic in order to reduce congestion on the network or to re-prioritize the data packets.

### DESCRIPTION OF THE DRAWINGS

FIG. 1 is a block diagram of a media gateway which interfaces one or more devices to a network.

FIG. 2 is a flowchart showing processing of data packets that occurs in the media gateway.

### DESCRIPTION

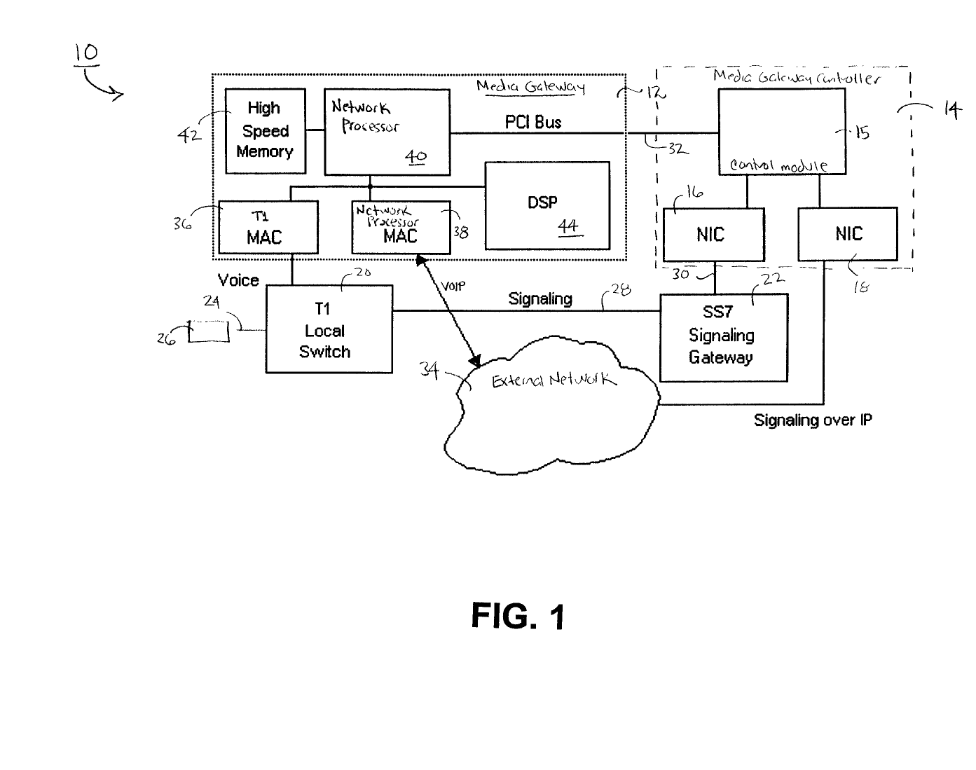

Referring to FIG. 1, a computer network 10 is shown. Computer network 10 includes the following hardware: media gateway 12, media gateway controller 14 (which includes network interface cards (NICs) 16 and 18 and control module 15), T1 local switch 20, and signaling gateway 22.

In this embodiment, data is transferred from a T1 line 24, through T1 local switch 20, to media gateway 12. The data may include voice information to implement VOIP and/or video information to implement streaming video. Other types of data may be transmitted along with, or instead of, this data.

In the case of VOIP, a user actives (e.g., picks-up) a handset 26, which is connected to T1 line 24. Voice and signaling information is transmitted from handset 26 to T1 local switch 20. The voice information comprises the content of the VOIP. The signaling information identifies the location of the handset and the target of the call. In more detail, the signaling information includes the network (e.g., IP) address of handset 26 and the telephone number of the person being called. In this context, “telephone number” can mean a standard nine-digit (with area code) telephone number or any other type of identifier for use with VOIP.

From T1 local switch 20, the voice information is transmitted to media gateway 12 and the signaling information is transmitted to signaling gateway 22. Signaling gateway 22 is an interface between the network 28 carrying the signaling information and a local bus 30. NIC 16 is an interface between local bus 30 and media gateway controller 14.

Media gateway controller 14, in particular control module 15, receives the signaling information (e.g., a number) via signaling gateway 22 and NIC 18 and translates the signaling information to network addressing information. In this embodiment, the network addressing information is a device IP address; however, the media gateway described herein is not limited to use with IP addresses.

Media gateway controller 14 provides the network addressing information to media gateway 12 via a peripheral component interconnect (PCI) bus 32. Media gateway 12 sends VOIP packets to device(s) identified by the network addressing information received from media gateway controller 14, as described in more detail below. Media gateway controller 14 also uses the signaling information to contact a device on a remote network 34, such as the Internet, and open a channel to that device. NIC 18 interfaces between media gateway controller 14 and remote network 34.

To open a channel to a device, media gateway controller 14 may send data packets to the IP address of a remote device. The data packets instruct the device to ready itself to receive VOIP data. The device may then issue a return confirmation that a channel has been opened and that it is ready to receive VOIP data packets. The VOIP data packets are sent to the remote device from media gateway 12, as described below.

In this embodiment, media gateway 12 includes T1 media access control (MAC) interface 36, network processor MAC interface 38, network processor 40, high-speed memory 42, and digital signal processor (DSP) 44. Media gateway 12 receives pulse-code-modulated (PCM) data from T1 local switch 20 and network addressing information (e.g., device IP address(es)) from media gateway controller 14. Media gateway 12 generates data packets from the data (in this case, VOIP data packets, but it may also generate streaming video, or other types, of data packets). Media gateway 12 sends the data packets to device(s) specified by the network addressing information.

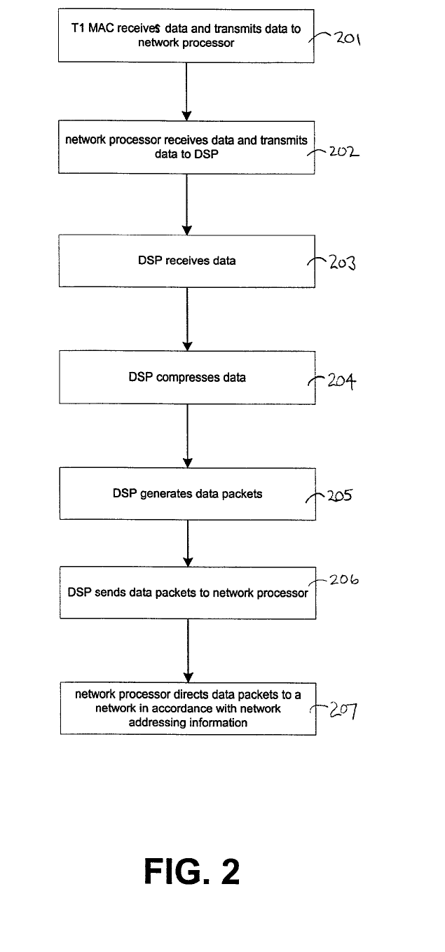

Referring to FIG. 2, T1 MAC interface 36 receives (201) the PCM data from T1 local switch 20. T1 MAC interface 36 transmits the PCM data to network processor 40. Network processor 40 executes one or more packet engines (not shown), which may be implemented in computer code, to store and route data packets. In this case, the packet engines receive (202) the PCM data from T1 MAC interface 36 and pass the PCM data to DSP 44. The packet engines may queue the data in high-speed memory 42 prior to passing the data to DSP 44.

DSP 44 receives (203) the PCM data from the packet engines, compresses (204) the data, and generates (205) data packets that correspond to the compressed data. For example, the PCM data may be in the form of T1 data packets. In this example, DSP 44 compresses the T1 data packets using a compression process, such as G.711 or G.728, and generates a different type of data packet, such as an asynchronous transfer mode (ATM) data packet, that contains the compressed data. DSP 44 may generate any type of data packet that is capable of being transmitted over a network. Any type of compression process may be used, not just those listed above. DSP 44 may also encrypt the data packets before the data packets are sent back to the packet engine(s) in network processor 40. Any type of encryption process may be used, such as PGP (Pretty Good Privacy) encryption. It is noted that encryption is optional and not necessary.

DSP 44 sends (206) the compressed (and maybe encrypted) data packets back to network processor 40. The packet engines receive the data packets and may queue the data packets in high-speed memory 42, if necessary, e.g., to reduce congestion on external network 34 and/or prioritize the data packets for transmission to external network 34. Network processor 40 also receives network addressing information (e.g., IP addresses) from media gateway controller 14. The network addressing information identifies one or more devices to which data packets are to be sent (i.e., devices with which media gateway controller 14 opened a channel—see above).

The packet engine(s) in network processor 40 direct (207) the compressed (and maybe encrypted) data packets to the device(s) on external network 34 that are identified by the addressing information. That is, the packet engines send the data packets to those devices via network processor MAC interface 38. Network processor MAC interface 38 may contain a controller or the like to regulate the flow of data packets between the packet engines and external network 34.

A remote device (not shown) on external network 34 that receives the data packets may respond in kind. The data packets from the remote device will travel through network processor MAC interface 38, to network processor 40, and then to DSP 44. DSP 44 decompresses and decrypts the data packets, if necessary, and converts the data packets to PCM data in a T1-format data packet. DSP 44 sends the data packets to network processor 40, which transmits them through T1 MAC interface 36 and T1 local switch 20 to handset 26.

A remote device may also set up a channel to another device via media gateway 12. In this case, the remote device sends signaling information to media gateway 12 via NIC 18 and media gateway controller 14. Media gateway 12 uses the signaling information to open up a channel between the other device and the remote device and, thereafter, to send data packets received from the remote device to the other device.

Media gateway 12 is described above in the context of VOIP. However, it has other uses, as noted. For example, media gateway 12 may be used to transmit streaming video. In this case, the signaling information includes a network address of a device to transmit the streaming video and a network address of a device to receive the streaming video (instead of a telephone number). Media gateway controller 14 sets up a channel between the two devices and the resulting video data packets are processed and transmitted in the same manner as the VOIP data packets described above.

Media gateway 12 also may be used to set up a secure virtual private network (VPN). In this example, the information sent between a sending device (in place of handset 26) and a remote receiving device comprises network addresses and encryption protocols necessary to set up the VPN. Otherwise, the data packet processing and transfer is the same as described in the example above. T1 MAC 36 can be replaced with an Internet MAC to implement the VPN. The Internet MAC and media gateway 10 can also be used to support a firewall.

The packet engines in network processor 40 may be implemented in computer programs executing on programmable computers or other machines that each includes a network processor and a storage medium readable by the processor.

Each such program may be implemented in a high level procedural or object-oriented programming language to communicate with a computer system. However, the programs can be implemented in assembly or machine language. The language may be a compiled or an interpreted language.

Each computer program may be stored on an article of manufacture, such as a CD-ROM, hard disk, or magnetic diskette, that is readable by network processor 40 to process data packets in the manner described above. The packet engines may also be implemented as a machine-readable storage medium, configured with one or more computer programs, where, upon execution, instructions in the computer program(s) cause the network processor to operate as described above.

Likewise DSP 44 contains computer code to implement its functions described above. The computer code may be implemented in computer programs executing on programmable computers or other machines that each include a DSP and a storage medium readable by the DSP.

Each such program may be implemented in a high level procedural or object-oriented programming language to communicate with a computer system. However, the programs can be implemented in assembly or machine language. The language may be a compiled or an interpreted language.

Each computer program may be stored on an article of manufacture, such as a CD-ROM, hard disk, or magnetic diskette, that is readable by DSP 44 to process data packets in the manner described above. The computer code may also be implemented as a machine-readable storage medium, configured with one or more computer programs, where, upon execution, instructions in the computer program(s) cause DSP 44 to operate in the manner described above.

The invention is not limited to the embodiments described above. For example, the invention is not limited to the specific hardware and software configurations described above. The invention is not limited to the protocols (e.g., encryption) described above. A standard, appropriately programmed, microprocessor or other controller could be used in lieu of network processor 40 and/or DSP 44. It is further noted that DSP 44 can reside on network processor 40, even though the two are shown separate in FIG. 1.

Other embodiments not described herein are also within the scope of the following claims.

What is claimed is:

1. An apparatus comprising:
a digital signal processor which receives data, compresses the data, and generates data packets that correspond to the compressed data; and
a packet engine which receives the data packets and directs the data packets to a network in accordance with network addressing information.

2. The apparatus of claim 1, further comprising:
a network interface which regulates a flow of the data packets between the packet engine and the network.

3. The apparatus of claim 1, wherein the data represents voice information for voice-over IP (VOIP).

4. The apparatus of claim 3, further comprising:
a media gateway controller which receives a telephone number, translates the telephone number to the network addressing information, provides the network addressing information to the packet engine, and opens a channel over the network using the network addressing information.

5. The apparatus of claim 1, wherein the network addressing information comprises a network Internet Protocol (IP) address.

6. The apparatus of claim 5, wherein the network comprises the Internet.

7. The apparatus of claim 6, wherein the packet engine directs the packets to the IP address on the Internet.

8. The apparatus of claim 1, wherein the packet engine is part of a network processor that includes multiple packet engines.

9. The apparatus of claim 1, wherein the data comprises T1 packets and the digital signal processor generates a different type of data packets than T1 packets.

10. The apparatus of claim 1, wherein the digital signal processor encrypts the data packets prior to the packet engine directing the data packets to the network.

11. The apparatus of claim 1, wherein the data comprises streaming video.

12. A method comprising:
using a digital signal processor to receive data, compress the data, and generate data packets that correspond to the compressed data; and
receiving the data packets at a packet engine which directs the data packets to a network in accordance with network addressing information.

13. The method of claim 12, further comprising:
regulating a flow of the data packets between the packet engine and the network.

14. The method of claim 12, wherein the data represents voice information for voice-over IP (VOIP).

15. The method of claim 14, further comprising:
receiving a telephone number;
translating the telephone number to the network addressing information;
providing the network addressing information to the packet engine; and
opening a channel over the network using the network addressing information.

16. The method of claim 12, wherein the network addressing information comprises a network Internet Protocol (IP) address.

17. The method of claim 16, wherein the network comprises the Internet.

18. The method of claim 17, wherein the packet engine directs the packets to the IP address on the Internet.

19. The method of claim 12, wherein the packet engine is part of a network processor that includes multiple packet engines.

20. The method of claim 12, wherein the data comprises T1 packets and the digital signal processor generates a different type of data packets than T1 packets.

21. The method of claim 12, further comprising encrypting the data packets in the digital signal processor prior to the packet engine directing the data packets to the network.

22. The method of claim 12, wherein the data comprises streaming video.

22. An apparatus comprising:
an interface device which receives a telephone number, translates the telephone number to an Internet Protocol address, and opens a channel over a network using the Internet Protocol address;
a digital signal processor which receives pulse-code modulated voice data, compresses the pulse-code modulated voice data, and generates data packets that correspond to the compressed pulse-code modulated voice data; and
a network processor which receives the Internet Protocol address from the interface device, receives the data packets from the digital signal processor, and directs the data packets to the network in accordance with the Internet Protocol address.

23. The apparatus of claim 22, wherein the digital signal processor encrypts the data packets prior to the network processor directing the data packets to the network.

24. The apparatus of claim 22, further comprising:
a network interface which regulates a flow of data packets between the network processor and the network.

25. An apparatus comprising:
an interface device which receives an address and opens a channel over a network using the address;
a digital signal processor which receives streaming video data, compresses the streaming video data, and generates data packets that correspond to the compressed streaming video data; and
a network processor which receives the address from the interface device, receives the data packets from the digital signal processor, and directs the data packets to the network in accordance with the address.

26. The apparatus of claim 25, wherein the digital signal processor encrypts the data packets prior to the network processor directing the data packets to the network.

27. The apparatus of claim 25, further comprising:
a network interface which regulates a flow of data packets between the network processor and the network.

28. An article comprising a machine-readable medium that stores executable instructions to process data packets, the instructions causing a machine to:
receive data from a packet engine on a network processor;
compress the data;
generate data packets that correspond to the compressed data; and
send the data packets back to the packet engine.

29. The article of claim 28, wherein the data represents voice information for voice-over IP (VOIP).

30. The article of claim 28, wherein the data comprises T1 packets and the data packets that are generated comprise a different type of data packets than T1 packets.
